(19) United States
(12) Patent Application Publication
(10) Pub. No.: US 2026/0290866 A1
(43) Pub. Date: Sep. 24, 2026

(54) HYDROCARBON FUEL CELL

(71) Applicants: Gun Myung LEE, Cheongju-si (KR); Jae Joon SEONG, Wonju-si (KR); Nak Young SEONG, Seongnam-si (KR)

(72) Inventors: Gun Myung LEE, Cheongju-si (KR); Jae Joon SEONG, Wonju-si (KR); Nak Young SEONG, Seongnam-si (KR)

(21) Appl. No.: 19/530,539

(22) Filed: Feb. 5, 2026

(30) Foreign Application Priority Data
Mar. 24, 2025 (KR) 10-2025-0037386

(51) Int. Cl. H01M 8/0662; H01M 4/86; H01M 8/04082; H01M 8/04119; H01M 8/0612; H01M 8/1231

(52) U.S. Cl. CPC H01M 8/0687; H01M 8/04156; H01M 8/04201; H01M 8/0612; H01M 8/1231; H01M 2004/8684

(57) ABSTRACT

A hydrocarbon fuel cell including a molecular decomposition chamber including a carbon-porous ceramic partition and a nickel-porous ceramic partition; an anode chamber disposed adjacent to the carbon-porous ceramic partition of the molecular decomposition chamber and equipped with a P-type semiconductor sidewall on an opposite sidewall; a cathode chamber disposed adjacent to the nickel-porous ceramic partition of the molecular decomposition chamber and equipped with an N-type semiconductor sidewall on an opposite sidewall; a pressure nozzle that sprays hydrocarbon fuel into the molecular decomposition chamber; an ultraviolet generator that irradiates the molecular decomposition chamber with ultraviolet light to decompose the hydrocarbon fuel into hydrogen ions and carbon ions; an oxygen injection unit that injects pressurized oxygen at a preset pressure into each of the anode chamber and the cathode chamber; and a power generation line that connects the P-type semiconductor sidewall and the N-type semiconductor sidewall.

### CROSS-REFERENCE TO RELATED APPLICATION

This application claims priority to and the benefit of Korean Patent Application No. 10-2025-0037386, filed on Mar. 24, 2025, the disclosure of which is incorporated herein by reference in its entirety.

### BACKGROUND

### 1. Field of the Invention

The present invention relates to a hydrocarbon fuel cell, and more particularly, to a minimized hydrocarbon fuel cell that can circulate electrons extracted through chemical decomposition of hydrocarbon fuel to produce electrical energy, minimize energy loss during the electrical energy production process, and accordingly minimize hydrocarbon fuel consumption.

### 2. Discussion of Related Art

A fuel cell is a device that directly generates electrical energy through a chemical reaction between a fuel and an oxidizing agent, and is being utilized in various industrial fields due to its high energy conversion efficiency and low environmental impact. However, conventional fuel cells have various problems due to their power generation method and structural limitations.

Conventional fuel cells generate power by moving electrons between an anode and a cathode. In this process, an electrolyte solution is used, and when the performance of the electrolyte degrades over time, the lifetime of the fuel cell becomes limited. When the electrolyte deteriorates or evaporates, electron movement is impaired, and as a result, the efficiency of the fuel cell decreases rapidly. Due to this problem, the fuel cell must be replaced or replenished after a certain period, resulting in increased maintenance costs.

Energy loss during the power generation process of a fuel cell is also a significant problem. In conventional technology, the process of converting the chemical energy of the fuel into electrical energy involves multiple stages. At each stage, energy is lost as heat, and the final rate of conversion to electrical energy is reduced. In particular, for fossil fuel-based fuel cells, a large amount of heat is generated during the combustion of the fuel, and if this heat is not effectively recovered, the overall energy conversion efficiency is further reduced.

A fuel cell using hydrocarbon fuel has the problem of high fuel consumption. If sufficient electrons are not extracted during the burning or decomposition of the fuel, more fuel must be supplied to produce the same amount of power. In conventional technology, devices that can efficiently control electron movement are lacking, which causes problems such as incomplete use of the fuel or unnecessary consumption of part of it. Accordingly, fuel consumption increases, fuel costs rise, and environmental pollutions may also occur due to incomplete combustion.

The lack of sustainability in power generation is also one of the problems of conventional fuel cells. For a fuel cell to operate stably, electron movement must be smooth, but in conventional technology, the electron transfer path is often designed inefficiently. If the electron flow is unstable, the voltage is not maintained at a constant level, which can lead to significant fluctuations in the output of the fuel cell. In particular, when used for industrial or large-scale power supply purposes, power stability is required, but conventional fuel cells have limitations in meeting these requirements.

The method of handling by-products generated inside a fuel cell also requires improvement. When hydrocarbon fuel is used, carbon dioxide (CO₂) and water (H₂O) are generated during the reaction, and if these are not properly exhausted, they can accumulate inside the fuel cell. In conventional technology, due to an inadequate system for efficiently exhausting by-products, the pressure inside the reaction chamber may increase or by-products may adhere to the electrode surface, thereby degrading the performance of the electrode. Accordingly, the overall efficiency of the fuel cell is reduced, and long-term use becomes difficult.

The durability of catalysts used in fuel cells must also be considered. The catalyst in a conventional fuel cell promotes chemical reactions, but its performance gradually degrades with prolonged use. In particular, when hydrocarbon fuel is used, coking occurs, increasing the possibility of catalyst surface contamination. As a result, reaction efficiency is reduced, and power generation capacity may decrease. When the catalyst becomes contaminated, it must be removed or replaced, which increases maintenance costs.

Structural problems are also present in fuel cells. Since conventional fuel cells are manufactured according to a specific design method, flexible design changes are difficult, and the types of fuel that can be applied may be limited. Some fuel cells exhibit optimal performance only under specific temperature or pressure conditions, and additional auxiliary devices may be necessary to meet these conditions. This can limit the applicability of fuel cells.

The manufacturing cost of fuel cells is also an important issue. Conventional fuel cells have high manufacturing costs due to their complex structures and various components, and mass production is often difficult. In particular, to manufacture high-performance fuel cells, expensive catalysts or heat-resistant materials must be used, which raises the price of the fuel cell.

To address the problems of the related art described above, the present invention aims to provide a hydrocarbon fuel cell that optimizes the chemical decomposition of hydrocarbon fuel to efficiently control electron flow, reduce fuel consumption, and ensure the sustainability and stability of power generation.

### RELATED ART DOCUMENT

### Patent Document

(Patent Document 1) Korean Registered Patent No. 10-2758751 (Registration Date: Jan. 17, 2025)

### SUMMARY OF THE INVENTION

The present invention is directed to providing a hydrocarbon fuel cell capable of overcoming the limited cell lifetime problem of conventional fuel cells that generate electrical energy through electron extraction, movement, and circulation using a negative electrode material and an electrolyte solution; addressing the energy loss in the conventional technology, which arises from generating electrical energy through multiple stages when using hydrocarbon fuel, as well as the problem of excessive hydrocarbon fuel consumption; and generating electrical energy by circulating electrons extracted through chemical decomposition of hydrocarbon fuel.

According to an aspect of the present invention, there is provided a hydrocarbon fuel cell including: a molecular decomposition chamber composed of a carbon-porous ceramic partition and a nickel-porous ceramic partition; an anode chamber disposed adjacent to the carbon-porous ceramic partition of the molecular decomposition chamber and equipped with a P-type semiconductor sidewall on an opposite sidewall; a cathode chamber disposed adjacent to the nickel-porous ceramic partition of the molecular decomposition chamber and equipped with an N-type semiconductor sidewall on an opposite sidewall; a pressure nozzle that sprays hydrocarbon fuel into the molecular decomposition chamber; an ultraviolet generator that irradiates the molecular decomposition chamber with ultraviolet light to decompose the hydrocarbon fuel into hydrogen ions and carbon ions; an oxygen injection unit that injects pressurized oxygen at a preset pressure into each of the anode chamber and the cathode chamber; and a power generation line that connects the P-type semiconductor sidewall and the N-type semiconductor sidewall while inducing electron flow to extract electrical power.

In an embodiment of the present invention, the molecular decomposition chamber may include: a carbon-porous ceramic partition disposed at one end of the sealed molecular decomposition chamber and separated from the anode chamber, and having a plurality of through-holes sized to block undecomposed carbon molecules while allowing decomposed carbon atoms to pass through; a nickel-porous ceramic partition disposed at the other end of the sealed molecular decomposition chamber and separated from the cathode chamber, and having a plurality of through-holes sized to block undecomposed hydrogen molecules and water molecules while allowing decomposed hydrogen atoms to pass through; and a carbon atom recombination prevention unit having a copper wire or copper mesh structure, disposed within the molecular decomposition chamber adjacent to the carbon-porous ceramic partition, electrically connected to the power generation line to receive electrons therefrom, and supplying electrons to decomposed carbon atoms to prevent recombination thereof and blockage of the through-holes of the carbon-porous ceramic partition.

In an embodiment of the present invention, the pressure nozzle may inject the hydrocarbon fuel into the molecular decomposition chamber in a mist form when the hydrocarbon fuel is methane gas, propane gas, or butane gas.

Furthermore, the pressure nozzle may inject hydrocarbon fuel into the molecular decomposition chamber in a vaporized form when the hydrocarbon fuel is liquid gasoline, liquid kerosene, or liquid diesel.

In an embodiment of the present invention, the anode chamber may include: a first oxygen inlet nozzle mounted on one side surface of the sealed anode chamber to receive oxygen supplied from the oxygen injection unit into the anode chamber; a carbon dioxide exhaust nozzle that exhausts carbon dioxide generated from the reaction between carbon and oxygen within the sealed anode chamber to the outside; and an electron movement promotion unit filling an interior of the sealed anode chamber and formed by bending or curving copper wire multiple times into a cotton ball-like form, electrically connected to the carbon atom recombination prevention unit to receive electrons therefrom, and promoting the movement of electrons that have passed through the carbon-porous ceramic partition toward the P-type semiconductor sidewall.

In an embodiment of the present invention, the cathode chamber may include: a second oxygen inlet nozzle mounted on one side surface of the sealed cathode chamber to receive oxygen supplied from the oxygen injection unit into the cathode chamber; and a water vapor exhaust nozzle that exhausts water vapor generated from the reaction between hydrogen and oxygen within the sealed cathode chamber to the outside.

In an embodiment of the present invention, the hydrocarbon fuel cell may include a case made of an insulating material to minimize heat loss by preventing heat energy, which is the bonding energy generated from the reactions in the anode chamber and the cathode chamber, from being dissipated to the outside.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating a hydrocarbon fuel cell according to an embodiment of the present invention;

FIG. 2 is a chemical reaction equation illustrating the decomposition of hydrocarbon fuel into carbon atoms and hydrogen atoms by intense ultraviolet irradiation within the molecular decomposition chamber of the hydrocarbon fuel cell according to an embodiment of the present invention;

FIG. 3 is a chemical reaction equation illustrating the combination reaction of carbon atoms with oxygen molecules within the anode chamber of the hydrocarbon fuel cell according to an embodiment of the present invention; and

FIG. 4 is a chemical reaction equation illustrating the combination reaction of hydrogen atoms with oxygen molecules within the cathode chamber of the hydrocarbon fuel cell according to an embodiment of the present invention.

### DETAILED DESCRIPTION OF EXEMPLARY EMBODIMENTS

Hereinafter, preferred embodiments of the present invention will be described in detail with reference to the drawings. Prior to such description, it should be noted that terms or words used in the present specification and claims should not be construed as being limited to their ordinary or dictionary meanings, but rather should be interpreted according to meanings and concepts consistent with the technical idea of the present invention.

In this specification, when it is stated that a component is positioned “on” another component, this includes not only cases where a component is in contact with another component, but also cases where another component is present between the two components. In this specification, when it is stated that a component “includes” another component, this means that, unless specifically stated otherwise, the component can further include other components, rather than excluding them.

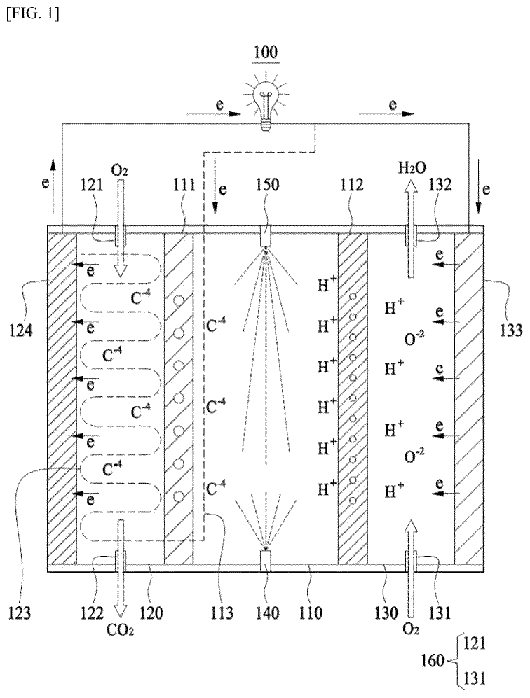

FIG. 1 is a schematic diagram illustrating a hydrocarbon fuel cell according to an embodiment of the present invention.

Referring to FIG. 1, the hydrocarbon fuel cell 100 according to the present embodiment includes a molecular decomposition chamber 110, an anode chamber 120, a cathode chamber 130, a pressure nozzle 140, an ultraviolet generator 150, an oxygen injection unit 160, and a power generation line 170 in a specific structure, thereby making it possible to overcome the limited cell lifetime problem of conventional fuel cells that generate electrical energy through electron extraction, transfer, and circulation using a negative electrode material and an electrolyte solution. Furthermore, it is possible to address the energy loss in the conventional technology, which arises from generating electrical energy through multiple stages when using hydrocarbon fuel, as well as the problem of excessive hydrocarbon fuel consumption, and generate electrical energy by circulating electrons extracted through chemical decomposition of hydrocarbon fuel.

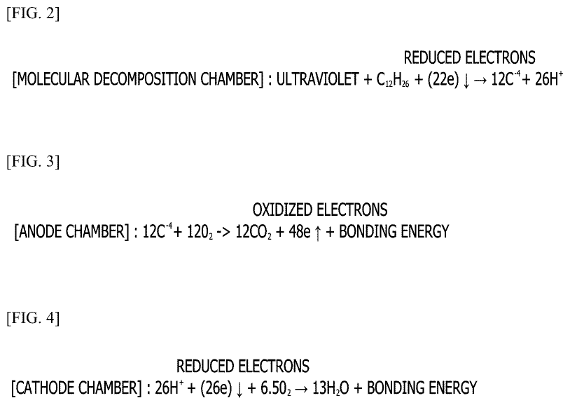

Hereinafter, with reference to FIGS. 1 to 4, each component constituting the hydrocarbon fuel cell 100 will be described in detail.

### Specific Configuration and Role of the Molecular Decomposition Chamber 110

The molecular decomposition chamber 110 serves as a core reaction space in which hydrocarbon fuel undergoes chemical decomposition to generate electrons and ions. In this space, hydrocarbon fuel is decomposed into carbon ions and hydrogen ions through ultraviolet irradiation and catalytic action, thereby enabling the initial reaction for power generation. Additionally, the molecular decomposition chamber 110 has a sealed structure designed to optimize internal reactions. It is important to maintain constant internal pressure and temperature, and for this purpose, appropriate materials and structural design are applied.

In the molecular decomposition chamber 110, a carbon-porous ceramic partition 111 and a nickel-porous ceramic partition 112 are respectively disposed to separate carbon and hydrogen. The carbon-porous ceramic partition 111, adjacent to the anode chamber 120, selectively allows carbon atoms to pass through. The nickel-porous ceramic partition 112, adjacent to the cathode chamber 130, selectively allows hydrogen atoms to pass through. This partition structure enables effective separation of carbon and hydrogen for power generation.

An ultraviolet generator 150 is installed within the molecular decomposition chamber 110 to decompose hydrocarbon fuel by irradiating it with strong ultraviolet light. By using specific wavelengths, hydrocarbon molecules may be decomposed directly into atomic states. In this process, the covalent bonds between carbon and hydrogen are broken, and carbon ions (C⁴⁻) and hydrogen ions (H⁺) are formed. The arrangement of the ultraviolet generator 150 is designed to enable uniform light irradiation and to maintain high reactivity.

A pressure nozzle 140 is installed within the molecular decomposition chamber 110 to spray fuel, and the spraying method may be adjusted based on the fuel state. Gaseous fuels such as methane, propane, and butane are sprayed in a mist form, while liquid fuels such as gasoline, kerosene, and diesel are sprayed in a vaporized state. This achieves uniform fuel diffusion, optimizing ultraviolet irradiation and reactivity.

The molecular decomposition chamber 110 is manufactured using materials with high heat resistance and durability to ensure stable operation under high-temperature and high-pressure conditions. Continuous carbon and hydrogen decomposition reactions inside the chamber may cause temperature rises. To prevent this, a thermal insulation structure may be applied, or the design may include features to control the internal reaction rate. Additionally, to maintain the long-term performance of the carbon-porous ceramic partition 111 and nickel-porous ceramic partition 112, appropriate surface treatments and structural reinforcements may be applied.

### Carbon-Porous Ceramic Partition 111

The carbon-porous ceramic partition 111 is disposed at one end of the molecular decomposition chamber 110 to selectively allow carbon atoms to move into the anode chamber 120. This partition has a specific porous structure designed to allow decomposed carbon atoms to pass through while blocking undecomposed hydrocarbon molecules. This porous structure controls carbon movement, prevents incomplete decomposition of fuel, and enhances power generation efficiency.

The pore size of the carbon-porous ceramic partition 111 is precisely designed in the nanometer (nm) range and optimized for the size and charge of carbon atoms. If the pore size is excessively large, undecomposed hydrocarbon molecules may pass through and inhibit reactions in the anode chamber 120; conversely, if it is excessively small, the movement of carbon atoms may be restricted, slowing the reaction rate. To prevent this, the pore size and distribution are precisely controlled to enable uniform movement of carbon atoms.

The carbon-porous ceramic partition 111 exhibits electrical conductivity and facilitates effective carbon atom movement. It minimizes electron movement paths to prevent voltage drops and enables smooth transfer of carbon atoms to the anode chamber 120. To this end, metal doping or a special coating that enhances electrical conductivity may be applied within the partition.

The surface of the carbon-porous ceramic partition 111 may include a structure to prevent the recombination of carbon atoms. Due to their high energy, carbon atoms tend to recombine, which may lead to the formation of unwanted deposits. To prevent this, the surface may be treated with electrophilic materials that promote the individual movement of carbon atoms, or a special coating may be applied to prevent carbon recombination.

The carbon-porous ceramic partition 111 is designed for high durability, minimizing physical deformation even during long-term operation. Since heat and pressure are repeatedly applied during continuous fuel cell operation, the partition requires materials with excellent heat resistance and wear resistance. Accordingly, ceramic materials capable of maintaining structural stability at high temperatures are used, and structural reinforcement may be applied to enhance the strength of the partition.

### Nickel-Porous Ceramic Partition 112

The nickel-porous ceramic partition 112 is disposed at one end of the molecular decomposition chamber 110 to selectively allow hydrogen atoms to move into the cathode chamber 130. This partition has a specific porous structure designed to allow decomposed hydrogen atoms to pass through while blocking undecomposed hydrogen molecules or water molecules. This porous structure controls hydrogen movement and prevents incomplete fuel decomposition, thereby maximizing power generation efficiency.

The nickel-porous ceramic partition 112 exhibits electrical conductivity and facilitates effective hydrogen atom movement. Nickel (Ni) has excellent electrical conductivity, facilitating smooth reactions in which hydrogen ions moving into the cathode chamber 130 combine with electrons to form water molecules. To this end, the nickel material is formed into a porous structure to increase the overall surface area of the partition, thereby enabling uniform movement of hydrogen atoms.

The pore size of the nickel-porous ceramic partition 112 is precisely designed based on the size and charge of hydrogen atoms. If the pore size is excessively large, undecomposed hydrogen molecules may pass through and inhibit reactions in the cathode chamber 130; conversely, if it is excessively small, the movement of hydrogen atoms may be restricted, slowing the reaction rate. To prevent this, the pore size and distribution are precisely controlled to enable uniform movement of hydrogen atoms.

The nickel-porous ceramic partition 112 is required to exhibit high heat resistance and maintain structural stability during continuous chemical reactions. Within the fuel cell, heat is generated as hydrogen atoms move, and high temperatures are sustained in this process. Therefore, to ensure that the partition does not deform at high temperatures and maintains a consistent structure, the partition is manufactured using ceramic materials and nickel alloys that are stable even at high temperatures.

The surface of the nickel-porous ceramic partition 112 may be subjected to surface treatment to promote the movement of hydrogen atoms and to prevent the accumulation of unwanted byproducts. Since hydrogen atoms are charged, they may adhere to the surface of the partition under certain conditions, thereby impeding movement. To prevent this, the surface may be treated with hydrophilic or special coatings to facilitate hydrogen movement paths, and a highly active catalyst layer may be added to prevent hydrogen recombination.

### Carbon Atom Recombination Prevention Unit 113

The carbon atom recombination prevention unit 113 serves to prevent recombination of decomposed carbon atoms within the molecular decomposition chamber 110, which could otherwise block the partition or reduce reactivity. Due to their high reactivity, carbon atoms may combine with each other to cause carbon coking if electrons are not supplied. To prevent this, the carbon atom recombination prevention unit 113 supplies electrons to carbon atoms so as to maintain the carbon atoms in an individual state.

The carbon atom recombination prevention unit 113 is formed primarily in a copper wire structure or copper mesh structure. Copper exhibits excellent electrical conductivity, thereby enabling efficient power supply and continuously providing electrons to carbon atoms to prevent bonding. In the copper wire structure, a plurality of copper wires are interconnected, thereby allowing carbon atoms to be uniformly distributed. In the copper mesh structure, a large surface area is provided, enabling carbon atoms to effectively remain in an individual state.

The carbon atom recombination prevention unit 113 is electrically connected to the power generation line 170 and is designed to supply electrons while maintaining a constant voltage. If the supply of electrons is unstable, carbon atoms may not be completely ionized and may recombine to form deposits. To prevent this, the carbon atom recombination prevention unit 113 maintains a constant voltage, thereby allowing carbon atoms to continuously move while remaining in an individual state.

The carbon atom recombination prevention unit 113 is disposed to allow carbon atoms to be uniformly diffused and is designed to harmonize with the porous structure of the partition. The carbon atom recombination prevention unit 113 is disposed at an appropriate position so as not to block the through-holes of the carbon-porous ceramic partition 111 and is structurally arranged to allow carbon atoms to move naturally into the anode chamber 120. Through this, carbon atoms may move smoothly, and reactivity may be maintained.

To enhance the durability of the carbon atom recombination prevention unit 113, surface treatment and material enhancement may be performed. The copper wire or mesh structure is required to maintain stable performance under continuous electron movement and high-temperature conditions. To this end, an oxidation-resistant coating or a heat-resistant enhanced alloy may be applied to secure long-term durability, and a movement path of the carbon atoms may be smoothly maintained.

### Specific Configuration and Role of the Anode Chamber 120

The anode chamber 120 is a space in which decomposed carbon ions (C⁴⁺) from the molecular decomposition chamber 110 move and react, and a process of converting the carbon ions into carbon dioxide (CO₂) by combining with oxygen (O₂) is performed in the chamber. During this process, carbon ions release electrons, and the released electrons are converted into electrical energy through the power generation line 170. Therefore, the anode chamber 120 serves as a core reaction space of the fuel cell, in which power generation and discharge of byproducts occur simultaneously.

The interior of the anode chamber 120 adopts a sealed structure and is configured to maintain a constant internal pressure and gas composition. An optimal environment is provided to allow decomposed carbon ions from the molecular decomposition chamber 110 to move efficiently. To this end, the interior of the anode chamber 120 is designed to allow smooth inflow of oxygen (O₂) and discharge of carbon dioxide (CO₂). If the internal pressure of the anode chamber 120 is not maintained at a constant level, the reaction rate may become unbalanced, thereby reducing the efficiency of the fuel cell.

An electron movement promotion unit 123 is disposed within the anode chamber 120 to facilitate a reaction in which carbon ions (C⁴⁻) that have passed through the partition smoothly combine with oxygen. The electron movement promotion unit 123 may be formed in a copper wire or mesh structure, providing an electrical connection that allows carbon ions to effectively release electrons. Additionally, it optimizes electron flow in conjunction with the power generation line 170.

A carbon dioxide exhaust nozzle 122 is installed on one side of the anode chamber 120 and serves to discharge carbon dioxide (CO₂) generated by the reaction to the outside. If the carbon dioxide is not properly exhausted, internal pressure may increase, resulting in degradation of fuel cell performance. Therefore, the carbon dioxide exhaust nozzle 122 is designed with an optimal size and placement to enable continuous exhaust and may be linked to an internal pressure control system.

The interior of the anode chamber 120 may be subjected to a special surface treatment or provided with a catalyst layer to enhance reaction efficiency. The catalyst layer may be added to promote the bonding reaction between carbon ions and oxygen, thereby increasing the reaction rate and maximizing power generation efficiency. Additionally, by applying high-durability materials to prevent contamination of internal surfaces during long-term operation, the lifetime of the fuel cell may be extended.

### First Oxygen Inlet Nozzle 121

The first oxygen inlet nozzle 121 injects oxygen (O₂) into the anode chamber 120 to facilitate bonding reactions between carbon ions (C⁴⁻) and oxygen. Since the oxygen supply rate and pressure in a fuel cell directly affect the efficiency of power generation, the first oxygen inlet nozzle 121 is designed to supply oxygen under optimal conditions.

The first oxygen inlet nozzle 121 is connected to the oxygen injection unit 160 and controls the inflow rate and amount of oxygen. If oxygen is excessively supplied, reaction efficiency may be reduced; conversely, if oxygen supply is insufficient, the output of the fuel cell may decrease. Therefore, a valve system capable of precisely controlling the amount of supplied oxygen may be included, and if necessary, may be linked to a sensor capable of automatically adjusting the oxygen supply amount.

The interior of the first oxygen inlet nozzle 121 is formed of a corrosion-resistant material to prevent corrosion and contamination and is designed to enable a constant oxygen supply even during long-term operation. Since oxygen is a highly reactive gas, contamination or corrosion in a supply path may cause degradation of fuel cell performance. To prevent this, a special coating having low reactivity with oxygen may be applied to the internal surface, and the internal structure is optimized to maintain a constant flow rate.

The outlet shape of the first oxygen inlet nozzle 121 is designed to allow oxygen to be uniformly diffused within the anode chamber 120. If oxygen is intensively supplied to a specific location, the reaction may proceed unevenly, thereby reducing power generation efficiency. Therefore, the outlet of the first oxygen inlet nozzle 121 may have a porous structure or may be formed in a fine spraying configuration to allow oxygen to be evenly distributed throughout the anode chamber 120.

The arrangement of the first oxygen inlet nozzle 121 is adjusted to optimize flow within the anode chamber 120. Oxygen is preferably supplied to a region where a reaction with carbon ions occurs most actively, and for this purpose, the injection direction and location of oxygen may be finely adjusted. Additionally, a structure capable of dynamically changing the amount and direction of oxygen supply according to an operating state of the fuel cell may be applied.

### Carbon Dioxide Exhaust Nozzle 122

The carbon dioxide exhaust nozzle 122 discharges carbon dioxide (CO₂), which is generated by a bonding reaction between carbon ions (C⁴⁻) and oxygen (O₂) within the anode chamber 120, to the outside. If carbon dioxide in the fuel cell is not properly exhausted, internal pressure may increase, thereby degrading fuel cell performance. Accordingly, the carbon dioxide exhaust nozzle 122 is designed to maintain smooth gas flow while balancing pressure with the external environment.

Since the carbon dioxide exhaust nozzle 122 is required to exhaust gas only after the reaction within the anode chamber 120 is completed, it is disposed to facilitate efficient carbon dioxide discharge. The nozzle is typically installed at an optimal location in consideration of gas flow patterns within the anode chamber 120 and may include a porous structure or a variable exhaust configuration to enhance discharge efficiency. This prevents unnecessary gas accumulation within the anode chamber 120 and enables continuous fuel cell operation.

The carbon dioxide exhaust nozzle 122 may include a valve system to regulate exhaust gas flow. If the exhaust rate is excessively high, the pressure inside the anode chamber 120 may change abruptly, disrupting the reaction equilibrium; conversely, if the exhaust rate is excessively low, carbon dioxide may accumulate, reducing the power generation efficiency of the fuel cell. To prevent this, an automatic exhaust system including automatic regulation valves or pressure-sensing sensors may be applied.

The carbon dioxide exhaust nozzle 122 is manufactured using highly corrosion-resistant materials and designed to maintain structural integrity during long-term operation. Carbon dioxide may combine with moisture to form carbonic acid, which may corrode metal components. To prevent this, corrosion-resistant coatings may be applied to the interior of the exhaust nozzle, and corrosion-resistant alloy materials may also be used.

The carbon dioxide exhaust nozzle 122 may be integrated with additional systems for treating exhaust gas. For example, a system for capturing and recycling carbon dioxide discharged from the fuel cell, or a system for purifying carbon dioxide before release to the outside, may be included. This may reduce carbon emissions and improve the environmental friendliness of the fuel cell. In addition, a function for monitoring carbon dioxide emissions to analyze the operating state of the fuel cell in real time may be included.

### Electron Movement Promotion Unit 123

The electron movement promotion unit 123 facilitates smooth electron flow from the carbon-porous ceramic partition 111 into a P-type semiconductor sidewall 124. Electrons are critical for power generation, and if resistance occurs during their movement, energy loss may increase. Thus, the electron movement promotion unit 123 optimizes electron flow to maximize power generation efficiency.

The electron movement promotion unit 123 consists of multiple copper wires bent or curved to fill the interior of the anode chamber 120 in a cotton ball-like structure. This high-surface-area copper structure guides electrons naturally toward the P-type semiconductor sidewall 124. In addition, highly conductive materials are used to minimize resistance in electron movement paths, with an optimized structure ensuring consistent electron flow.

The internal structure of the electron movement promotion unit 123 is designed to balance its operation with carbon dioxide discharge. Since it is closely integrated with a reaction space in which carbon and oxygen react, the electron movement promotion unit 123 is required to maintain an adequate spacing to allow carbon dioxide generated by the reaction to be smoothly discharged. To this end, the electron movement promotion unit 123 may be bent at regular intervals or include a porous structure, thereby preventing interference with the flow within the reaction space.

The electron movement promotion unit 123 is electrically connected to the power generation line 170 and is designed to maintain efficient electron flow. Since the power generation line 170 directly contributes to the power output of the fuel cell, it is important that the electrons supplied from the electron movement promotion unit 123 are stably maintained. To this end, the electron movement promotion unit 123 is precisely manufactured to supply electrons while maintaining a constant voltage, and may include additional circuitry to regulate electron flow as needed.

The electron movement promotion unit 123 is formed of materials with high durability and designed to maintain performance over long-term operation. Since a fuel cell is operated continuously, physical or chemical changes in internal components may lead to degradation of overall system performance. To prevent this, the electron movement promotion unit 123 may include corrosion-resistant coatings, or durable alloys or composite materials may be used. Additionally, its structure may be designed to facilitate periodic maintenance for sustaining long-term electron transfer efficiency.

### P-type Semiconductor Sidewall 124

The P-type semiconductor sidewall 124 is a critical component that accumulates electrons moved from the anode chamber 120 and directs electron flow toward the cathode chamber 130 through the power generation line 170. With its electron-deficient characteristics, the P-type semiconductor is designed to efficiently collect electrons emitted from the anode chamber 120. As a result, a continuous electron flow is maintained, thereby enabling stable electrical power generation in the fuel cell.

The P-type semiconductor sidewall 124 is disposed at a regular distance from the carbon-porous ceramic partition 111 in the anode chamber 120. This spacing allows electrons released during the reaction in which carbon ions (C⁴⁻) combine with oxygen to form carbon dioxide (CO₂) to flow into the P-type semiconductor sidewall 124 in a natural manner. If the spacing is excessively narrow, electron flow may be obstructed; conversely, if the spacing is excessively wide, electron movement may be reduced. Accordingly, the P-type semiconductor sidewall 124 is designed to maintain an optimal spacing.

The material of the P-type semiconductor sidewall 124 is selected to provide high charge carrier mobility. Boron (B) is typically doped into silicon (Si) to impart P-type characteristics, thereby enabling efficient electron movement. In addition, surface treatment techniques may be applied to optimize electron injection and accumulation, further enhancing the conductivity of the semiconductor.

Contact points directly connected to the power generation line 170 are formed on the P-type semiconductor sidewall 124, inducing electrons to flow toward the cathode chamber 130. The configuration of the contact points is critical for optimizing electron flow and is designed to minimize electron resistance while maintaining stable power flow. The size and position of the contact points directly determine the output voltage and power capacity of the fuel cell.

The P-type semiconductor sidewall 124 is manufactured to have high durability to prevent performance degradation during long-term operation. Since semiconductor materials are continuously exposed to heat and electrical current, materials with high heat resistance and durability may be used. Additionally, protective coatings may be applied to minimize the influence of external environmental factors, thereby ensuring stable electron movement and extending the lifetime of the semiconductor.

### Specific Configuration and Role of the Cathode Chamber 130

The cathode chamber 130 is the space in which hydrogen ions (H⁺) decomposed in the molecular decomposition chamber 110 migrate and combine with oxygen to form water (H₂O), and it is one of the primary reaction chambers in the fuel cell where power generation and chemical reaction occur. In this process, hydrogen ions pass through the nickel-porous ceramic partition 112, move into the cathode chamber 130, and react with oxygen (O₂) to form water.

A second oxygen inlet nozzle 131 is disposed within the cathode chamber 130 for oxygen injection. Since the reaction between hydrogen ions and oxygen to form water requires precisely controlled conditions, the cathode chamber 130 is designed to maintain a constant internal pressure and oxygen concentration. An insufficient oxygen concentration may hinder the progression of the reaction, whereas an excessive oxygen supply may disturb the reaction equilibrium.

The internal structure of the cathode chamber 130 is optimized to enable efficient reaction between hydrogen ions and oxygen. The interior is designed to allow hydrogen ions to be uniformly diffused, and porous structures may be incorporated to increase the oxygen reaction surface area. Additionally, highly thermal-conductive materials may be used to effectively dissipate heat generated during the hydrogen-oxygen combination process.

A water vapor exhaust nozzle 132 is disposed on one side of the cathode chamber 130 to discharge water produced after the reaction in the form of vapor. Water generated in the fuel cell is required to be properly managed to ensure continuous operation. If discharge paths are obstructed, water accumulation within the chamber may degrade fuel cell performance. Accordingly, the water vapor exhaust nozzle 132 is designed to discharge water at a constant flow rate and may be integrated with a condensate recovery system for water reuse as needed.

Materials with excellent heat resistance and corrosion resistance are used to maintain the structural stability of the cathode chamber 130. The hydrogen-oxygen combination process demands high reactivity and continuously generates elevated temperatures and humidity. Durable materials are selected to withstand these conditions, and corrosion-resistant coatings may be applied to internal surfaces. Additionally, the cathode chamber 130 may be designed for easy maintenance to sustain long-term fuel cell performance.

### Second Oxygen Inlet Nozzle 131

The second oxygen inlet nozzle 131 supplies oxygen (O₂) into the cathode chamber 130 and plays an essential role in the power generation process of the fuel cell. Efficient progression of the reaction in which hydrogen ions (H⁺) combine with oxygen to form water (H₂O) requires a continuous supply of adequate oxygen. To this end, the second oxygen inlet nozzle 131 injects oxygen at appropriate flow rates and pressures, and is designed to maintain a constant oxygen concentration.

The second oxygen inlet nozzle 131 is connected to the oxygen injection unit 160 and configured to precisely control the oxygen supply rate and pressure. An excessive oxygen supply may disrupt reaction equilibrium within the fuel cell, whereas an insufficient supply may decrease the reaction rate, thereby reducing power generation efficiency. To prevent this, the nozzle may include a valve system and is designed to operate in conjunction with sensors featuring automatic regulation to ensure optimal oxygen supply.

The internal structure of the second oxygen inlet nozzle 131 is designed to enable uniform oxygen diffusion. In typical fuel cells, concentrated oxygen supply to specific areas may cause reaction imbalances, with reduced reaction efficiency in some regions due to oxygen shortages. To prevent this, the outlet of the second oxygen inlet nozzle 131 is designed with a porous structure or manufactured in a fine spray form, enabling uniform oxygen diffusion throughout the cathode chamber 130.

The second oxygen inlet nozzle 131 is manufactured using highly corrosion-resistant materials to prevent corrosion and contamination. Due to the high reactivity of oxygen, long-term operation may cause corrosion or contamination inside the nozzle. To prevent this, special coatings with low reactivity to oxygen may be applied, and the internal structure is optimized to maintain consistent flow rates. Additionally, a filter system may be included to prevent foreign matter from entering the oxygen supply path.

The second oxygen inlet nozzle 131 may be configured to allow variable flow rate adjustment according to the operating conditions of the fuel cell. If the fuel cell output increases, a greater amount of oxygen is required; conversely, if the output decreases, the oxygen supply should be reduced. To achieve this, variable flow regulation devices may be included, and the nozzle may be integrated with an automated control system that monitors real-time fuel cell operational status to deliver the optimal oxygen supply.

### Water Vapor Exhaust Nozzle 132

The water vapor exhaust nozzle 132 serves to discharge water (H₂O ), generated by the combination of hydrogen ions (H⁺) and oxygen (O₂) in the cathode chamber 130, to the outside. In a fuel cell, water is generated as a byproduct of the reaction, and if water is not adequately discharged, it may accumulate in the cathode chamber 130, thereby hindering smooth progression of the reaction. Thus, the water vapor exhaust nozzle 132 is designed with an optimal structure to allow continuous discharge of the generated water to the outside.

The water vapor exhaust nozzle 132 is disposed at an optimal location in consideration of the internal pressure and temperature of the cathode chamber 130. To discharge the generated water in vapor form, constant pressure and temperature conditions must be maintained within the chamber. To this end, the nozzle size and discharge rate are adjusted. An excessively high discharge rate may cause rapid changes in internal pressure, whereas an excessively low rate may lead to water accumulation within the chamber, resulting in a decrease in reaction efficiency.

The water vapor exhaust nozzle 132 may be designed to prevent condensation. Depending on the operating environment of the fuel cell, a decrease in temperature may cause the water vapor to condense and remain as liquid water within the exhaust nozzle. To prevent this, heating devices or hydrophilic coatings may be applied to the interior of the exhaust nozzle, and flow paths may be optimized to facilitate smooth discharge of the water.

The water vapor exhaust nozzle 132 may be integrated with additional treatment systems to properly regulate discharged water vapor in relation to external conditions. For example, a system that condenses the discharged water vapor and recycles it as purified water may be applied, thereby improving the overall efficiency of the fuel cell. In addition, a function may be included to monitor the amount and rate of discharged water vapor in real time, enabling analysis of the operating state of the fuel cell.

The water vapor exhaust nozzle 132 is manufactured using materials with high durability to prevent deformation or contamination during long-term operation. Since continuous contact with water may cause corrosion, corrosion-resistant coatings may be applied to the internal surfaces, and the structure is optimized to maintain high mechanical strength. Furthermore, a modular design may be adopted to facilitate maintenance.

### N-type Semiconductor Sidewall 133

The N-type semiconductor sidewall 133 performs a critical function by accepting electrons within the cathode chamber 130 and directing electron flow toward the P-type semiconductor sidewall 124 of the anode chamber 120 through the power generation line 170. An N-type semiconductor contains a large number of free electrons and is designed to allow electrons to move easily, thereby ensuring a stable electron flow during the power generation process of the fuel cell.

The N-type semiconductor sidewall 133 is disposed at a regular distance from the nickel-porous ceramic partition 112. This spacing facilitates the process in which the N-type semiconductor sidewall 133 accepts electrons and transfers them to the power generation line 170 as hydrogen ions (H⁺) pass through the nickel-porous ceramic partition 112 and move into the cathode chamber 130. Since an unbalanced electron flow may degrade power generation efficiency, optimal positioning and spacing are critical in the design.

The N-type semiconductor sidewall 133 is formed of silicon (Si) doped with impurities such as phosphorus (P) and arsenic (As) to impart N-type characteristics and is designed to maximize electron mobility. The semiconductor material exhibits high electrical conductivity, and when connected to an external electron source, minimizes energy loss due to low electrical resistance. Additionally, surface treatment techniques may be applied to maintain stable electron flow, thereby increasing electron concentration.

Contact points directly connected to the power generation line 170 are formed on the N-type semiconductor sidewall 133, inducing electrons to flow toward the P-type semiconductor sidewall 124 of the anode chamber 120. The size and placement of contact points are critical factors that determine the output power and voltage of the fuel cell, and are designed to minimize electron resistance while maintaining stable power flow. Furthermore, specialized metal plating or low-resistance materials may be applied to prevent electron loss at the contact points.

The N-type semiconductor sidewall 133 is designed to maintain high durability, and protective coatings may be applied to prevent degradation of conductivity during long-term operation. Since continuous chemical reactions and current flow occur within the fuel cell, contamination or damage of the semiconductor surface may reduce power generation efficiency. To prevent this, materials with high heat resistance and durability may be used, and a modular design may be adopted to facilitate maintenance.

### Specific Configuration and Role of the Pressure Nozzle 140

The pressure nozzle 140 sprays hydrocarbon fuel into the molecular decomposition chamber 110 and is designed to adjust spray methods based on the fuel type and physical state. For efficient operation of the fuel cell, the fuel is required to be uniformly diffused and to provide a sufficient reaction surface area. To this end, the pressure nozzle 140 is designed to generate specific injection patterns.

The pressure nozzle 140 uses different spraying methods depending on the physical state of fuel. Gaseous fuels such as methane, propane, and butane are sprayed in a fine mist form for rapid diffusion within the molecular decomposition chamber 110. On the other hand, liquid fuels such as gasoline, kerosene, and diesel are vaporized and injected as gas to optimize fuel decomposition reactions.

The pressure nozzle 140 is designed to allow precise control of spray pressure and flow rate. An excessive fuel supply may cause incomplete combustion, whereas an insufficient fuel supply may reduce power generation efficiency. To prevent this, an automatic regulation valve system may be included, which monitors the fuel supply in real time to ensure optimal fuel injection.

The internal surfaces of the pressure nozzle 140 are formed of materials having high corrosion resistance and are designed to maintain performance during long-term operation. Since hydrocarbon fuels exhibit high reactivity, prolonged fuel supply may cause carbon coking within the nozzle. To prevent coking, alloy materials with excellent heat resistance and wear resistance may be used, and specialized coatings may be applied as needed.

The pressure nozzle 140 may be designed with a modular structure that allows flexible adjustment according to the operating conditions of fuel cell. By designing the nozzle to be replaceable or adjustable when fuel types or operating conditions change, maintenance and operational efficiency may be improved. In addition, sensors that monitor nozzle conditions in real time may be included, thereby ensuring stable fuel supply and optimal fuel consumption.

### Specific Configuration and Role of the Ultraviolet Generator 150

The ultraviolet generator 150 is disposed within the molecular decomposition chamber 110 and performs a critical function in the chemical decomposition of hydrocarbon fuel. It uses intense ultraviolet energy to break hydrocarbon molecular bonds, facilitating decomposition into carbon ions (C⁴⁻) and hydrogen ions (H⁺). This method provides higher efficiency compared to conventional thermal decomposition while minimizing incomplete combustion.

The ultraviolet generator 150 is designed to emit ultraviolet light having a specific wavelength range. Effective decomposition of hydrocarbon fuel requires high-energy ultraviolet radiation (UV-C, 200 to 280 nm range), which directly breaks the covalent bonds of hydrocarbon molecules. Maintaining an optimal irradiance level is important, as insufficient UV intensity may result in reduced decomposition efficiency.

The placement of the ultraviolet generator 150 is optimized in consideration of fuel diffusion patterns within the molecular decomposition chamber 110. The ultraviolet generator 150 is typically mounted on the ceiling or at the center so that the fuel is uniformly irradiated with ultraviolet light, and multiple ultraviolet lamps may be arranged, if needed, to maximize the irradiation area. This ensures sufficient light absorption by the fuel and enables rapid and uniform decomposition.

The ultraviolet generator 150 is manufactured using materials with high heat resistance and durability and is designed to maintain stable performance during long-term operation. Since fuel cells operate at high temperatures, ultraviolet lamps may be protected by specialized quartz glass or heat-resistant polymers. Additionally, the output power of the lamp may be precisely controlled through a regulated power supply circuit.

The ultraviolet generator 150 may be designed with a modular structure to facilitate maintenance. Since the lifetime of the ultraviolet lamp may decrease with extended use, designing the lamp to be easily replaceable may improve operational efficiency of the fuel cell. In addition, sensors for monitoring ultraviolet intensity in real time may be included, thereby maintaining an optimal irradiation environment and enabling early detection of performance degradation of the ultraviolet lamp.

### Specific Configuration and Role of the Oxygen Injection Unit 160

The oxygen injection unit 160 supplies oxygen (O₂) to the anode chamber 120 and the cathode chamber 130, serving as a critical reaction component for the fuel cell. Oxygen is essential for the reactions in which oxygen combines with carbon ions (C⁴⁻) to form carbon dioxide (CO₂) and with hydrogen ions (H⁺) to form water (H₂O ). Thus, precise control of the oxygen supply rate and amount is a key factor in determining fuel cell performance.

The oxygen injection unit 160 injects oxygen into the anode chamber 120 and the cathode chamber 130 through the first oxygen inlet nozzle 121 and the second oxygen inlet nozzle 131, respectively, thereby facilitating smooth chemical reactions within the fuel cell. Insufficient oxygen supply may delay reactions or cause incomplete combustion, whereas excessive oxygen supply may induce internal pressure changes that reduce fuel cell stability. Therefore, the oxygen injection unit 160 serves to maintain oxygen supply at an optimal level.

The oxygen injection unit 160 may include automatic regulation valves to adjust the oxygen flow rate, thereby enabling real-time adjustment of the oxygen supply according to the operating state of the fuel cell. When fuel cell output increases, the oxygen supply is increased; conversely, when the output decreases, the oxygen supply is reduced. This approach enables efficient energy utilization while minimizing fuel consumption.

The oxygen injection unit 160 is manufactured using highly corrosion-resistant materials and is designed to prevent oxidation-induced corrosion during long-term operation. Since oxygen is highly reactive, internal pipes and nozzles are exposed to oxidation over long-term operation. To prevent this, corrosion-resistant coatings may be applied to internal surfaces, and highly corrosion-resistant alloy materials may be used.

The oxygen injection unit 160 may be integrated with an automated control system in connection with the operating environment of the fuel cell, thereby enabling real-time monitoring and optimization of oxygen supply. Oxygen concentration sensors may continuously measure internal oxygen levels, and the oxygen supply may be adjusted based on the measured values. This approach maximizes reaction efficiency and maintains stable power generation.

### Specific Configuration and Role of the Power Generation Line 170

The power generation line 170 is a critical component that collects electrons generated within the fuel cell and delivers them to external circuits, thereby supplying electrical energy. Power generation in the fuel cell is based on electron flow, and the power generation line 170 transfers electrons released from the P-type semiconductor sidewall 124 to the N-type semiconductor sidewall 133. Through this process, an electrical current is formed and actual electrical power is generated.

The power generation line 170 is designed to optimize electron movement paths to minimize energy loss. Since resistance generated during electron movement may increase power loss, the wiring of the power generation line 170 is formed of a high-conductivity material having low resistance. Typically, copper (Cu) or silver (Ag) metals are used, and as needed, specialized coatings or composite materials may be used to further optimize electron flow.

The power generation line 170 is designed to regulate electron flow between the interior of the fuel cell and an external load. Since the voltage and current of the fuel cell may vary depending on load requirements, power regulation circuits may be included to adjust the voltage or current. DC-DC converters or power conditioners may be applied to prevent voltage fluctuations and maintain stable power supply.

Insulation treatment is essential to maintain the durability and stability of the power generation line 170 against external environmental factors. Since fuel cells may operate under high-temperature and high-humidity conditions, insulation coatings may be applied to protect the power generation line 170 from damage due to external factors. In addition, electromagnetic interference (EMI) shielding may be included to ensure stable power flow.

The power generation line 170 may perform real-time monitoring and optimization in conjunction with a power management system of the fuel cell. By detecting changes in power output and adjusting current flow as needed, fuel cell efficiency may be maximized. Additionally, continuous analysis of the operating state of the fuel cell may enable early detection of abnormal conditions and optimization of maintenance cycles.

The hydrocarbon fuel cell 100 of the present invention operates on the principle of chemically decomposing hydrocarbon fuel to release electrons, with the released electrons moving along specific paths to generate electricity.

First, within the molecular decomposition chamber 110, the ultraviolet generator 150 irradiates the hydrocarbon fuel with strong ultraviolet light to break its chemical bonds. Through this process, the hydrocarbon fuel is decomposed into carbon ions (C⁴⁻) and hydrogen ions (H⁺), preparing them for transfer to the anode chamber 120 and the cathode chamber 130, respectively. The decomposed carbon ions (C⁴⁻) pass through the carbon-porous ceramic partition 111 into the anode chamber 120, while the hydrogen ions (H⁺) pass through the nickel-porous ceramic partition 112 into the cathode chamber 130.

In the anode chamber 120, the carbon ions (C⁴⁻) combine with oxygen (O₂) to form carbon dioxide (CO₂), thereby releasing the electrons (e⁻) carried by the carbon ions. The released electrons move along the electron movement promotion unit 123 and accumulate on the P-type semiconductor sidewall 124. As electrons accumulate on the P-type semiconductor sidewall 124, a potential difference is generated, which moves the electrons along the power generation line 170.

The power generation line 170 delivers the released electrons to an external circuit, thereby generating electrical energy. After passing through the external circuit, the electrons move along the N-type semiconductor sidewall 133 into the cathode chamber 130. In the cathode chamber 130, oxygen (O₂) supplied through the second oxygen inlet nozzle 131 reacts with hydrogen ions (H⁺) that have moved through the nickel-porous ceramic partition 112 to form water (H₂O ), which absorbs electrons.

This cycle repeats to maintain a continuous electron flow, enabling continuous power generation. The present invention overcomes the limitations of electrolytes in conventional fuel cells and optimizes electron movement paths to maximize energy conversion efficiency. In addition, by generating power through direct electron circulation, the present invention minimizes unnecessary energy losses and enables efficient fuel utilization. As a result, the fuel cell of the present invention operates by releasing electrons through chemical reactions between carbon ions and hydrogen ions, with the released electrons moving along specific paths through the external circuit to generate electrical energy.

As described above, the hydrocarbon fuel cell of the present invention overcomes the limitations of conventional fuel cells and provides a technology that maximizes efficient fuel utilization and stable power generation. Conventional fuel cells have an electrolyte-based structure for electron movement, and their lifetime has been limited due to performance degradation of the electrolyte. In contrast, the present invention generates electrons through direct chemical decomposition of hydrocarbon fuel and sustains continuous electron circulation, thereby achieving a longer lifetime compared to electrolyte-based cells.

One significant effect of the present invention is the resolution of energy loss issues in conventional fuel cells. Conventional technologies require multi-stage reactions during chemical conversion of fuel, leading to substantial thermal energy losses. In contrast, the present invention directly decomposes hydrocarbon fuel through ultraviolet irradiation and partition reactions to extract electrons, thereby minimizing unnecessary energy losses from multi-stage conversions. Thus, higher power generation efficiency may be achieved even with the same amount of fuel.

Another significant effect of the present invention is addressing excessive hydrocarbon fuel consumption. Conventional fuel cells require a large amount of oxygen for complete fuel combustion, often resulting in fuel waste from incomplete combustion. The present invention prevents incomplete combustion by spraying hydrocarbon fuel as fine particles and directly breaking chemical bonds using the ultraviolet generator 150. As a result, equivalent power output is achieved with reduced fuel consumption, enhancing economic efficiency.

The present invention also improves power generation sustainability and stability. Conventional fuel cells frequently exhibit unstable electron flow and severe power fluctuations, limiting applicability for large-scale power supply. In contrast, the present invention regulates electron movement using the P-type semiconductor sidewall 124 and the N-type semiconductor sidewall 133 and maintains stable voltage and current through the power generation line 170. As a result, the present invention enables long-term stable operation and extends applicability to industrial and large-scale power supply.

The present invention optimizes byproduct treatment in the fuel cell to resolve issues in conventional technologies. In conventional fuel cells, when carbon dioxide (CO₂) and water vapor (H₂O ) generated during the reaction are not smoothly discharged, internal pressure increases, potentially destabilizing fuel cell operation. The present invention includes the carbon dioxide exhaust nozzle 122 and the water vapor exhaust nozzle 132 to enable rapid byproduct discharge, which are linked with an internal pressure regulation system to maximize fuel cell stability.

Improving fuel cell maintenance and durability is also an important feature of the present invention. Conventional fuel cells require replacement after a certain period due to issues such as catalyst contamination and electrolyte degradation, leading to increased maintenance costs. The present invention uses the carbon-porous ceramic partition 111 and the nickel-porous ceramic partition 112 to ensure physical and chemical stability, enabling long-term use without catalyst contamination. This extends maintenance cycles and reduces overall operating costs for the fuel cell.

Finally, the present invention overcomes the structural limitations of conventional fuel cells to enable compatibility with a wide range of fuel types. Conventional technologies feature structures optimized for specific fuels, resulting in performance degradation when using other fuels. The present invention adjusts spraying methods for gaseous and liquid fuels through the pressure nozzle 140 and includes the carbon atom recombination prevention unit 113 and the electron movement promotion unit 123 to stably utilize diverse fuels. This broadens the scope of fuel cell applications and enables application in various industrial environments.

As described above, according to the hydrocarbon fuel cell of the present invention, by providing a molecular decomposition chamber, an anode chamber, a cathode chamber, a pressure nozzle, an ultraviolet generator, an oxygen injection unit, and a power generation line in a specific structure, it is possible to overcome the limited cell lifetime problem of conventional fuel cells that generate electrical energy through electron extraction, transfer, and circulation using a negative electrode material and an electrolyte solution. Furthermore, it is possible to address the energy loss in the conventional technology, which arises from generating electrical energy through multiple stages when using hydrocarbon fuel, as well as the problem of excessive hydrocarbon fuel consumption, and generate electrical energy by circulating electrons extracted through chemical decomposition of hydrocarbon fuel.

Additionally, according to the hydrocarbon fuel cell of the present invention, it is possible to transform the current method of generating a large amount of electricity at a single site and distributing it to multiple locations into a decentralized system that generates and supplies electricity in medium-and small-scale capacities at multiple sites according to local demand, thereby reducing economic losses incurred in the production, transportation, and storage of electrical power.

Furthermore, according to the hydrocarbon fuel cell of the present invention, since the method involves decomposing fuel into atomic units and extracting electrons only for power generation, the theoretical electrical generation efficiency in the anode chamber of the present invention can be close to 100%, as losses begin only when power is transmitted externally, and it can be said to be a production method with minimized fuel consumption.

Moreover, according to the hydrocarbon fuel cell of the present invention, since no electrolyte solution is used, it is evaluated as a method that fundamentally prevents safety accidents and environmental pollution originating from it, and the cell lifetime is expected to extend with advancements in the durability of ceramics and semiconductors.

Additionally, according to the hydrocarbon fuel cell of the present invention, although it may be perceived as contradicting carbon reduction policies because it generates carbon dioxide, it enhances carbon reduction effects through reduced fuel consumption from increased energy production efficiency, along with savings in electrical energy storage and transportation costs.

The foregoing detailed description of the present invention has only described specific embodiments thereof. However, the present invention should not be construed as limited to the particular forms mentioned in the detailed description; rather, it should be understood to encompass all modifications, equivalents, and substitutes falling within the spirit and scope of the present invention as defined by the appended claims.

In particular, the present invention is not limited to the specific embodiments and descriptions set forth above, and any person having ordinary knowledge in the technical field to which the present invention pertains may implement various modifications without departing from the scope of the claims, and such modifications fall within the scope of protection of the present invention.

### DESCRIPTION OF REFERENCE NUMERALS

100: Hydrocarbon fuel cell
110: Molecular decomposition chamber
111: Carbon-porous ceramic partition
112: Nickel-porous ceramic partition
113: Carbon atom recombination prevention unit
120: Anode chamber
121: First oxygen inlet nozzle
122: Carbon dioxide exhaust nozzle
123: Electron movement promotion unit
124: P-type semiconductor sidewall
130: Cathode chamber
131: Second oxygen inlet nozzle
132: Water vapor exhaust nozzle
133: N-type semiconductor sidewall
140: Pressure nozzle
150: Ultraviolet generator
160: Oxygen injection unit
170: Power generation line

What is claimed is:

1. A hydrocarbon fuel cell comprising:
a molecular decomposition chamber (110) composed of a carbon-porous ceramic partition (111) and a nickel-porous ceramic partition (112);
an anode chamber (120) disposed adjacent to the carbon-porous ceramic partition (111) of the molecular decomposition chamber (110) and equipped with a P-type semiconductor sidewall (124) on an opposite sidewall;
a cathode chamber (130) disposed adjacent to the nickel-porous ceramic partition (112) of the molecular decomposition chamber (110) and equipped with an N-type semiconductor sidewall (133) on an opposite sidewall;
a pressure nozzle (140) that sprays hydrocarbon fuel into the molecular decomposition chamber (110);
an ultraviolet generator (150) that irradiates the molecular decomposition chamber (110) with ultraviolet light to decompose the hydrocarbon fuel into hydrogen ions and carbon ions;
an oxygen injection unit (160) that injects pressurized oxygen at a preset pressure into each of the anode chamber (120) and the cathode chamber (130); and
a power generation line (170) that connects the P-type semiconductor sidewall (124) and the N-type semiconductor sidewall (133) while inducing electron flow to extract electrical power.

2. The hydrocarbon fuel cell of claim 1, wherein the molecular decomposition chamber (110) includes:
a carbon-porous ceramic partition (111) disposed at one end of the sealed molecular decomposition chamber (110) and separated from the anode chamber (120), and having a plurality of through-holes sized to block undecomposed carbon molecules while allowing decomposed carbon atoms to pass through;
a nickel-porous ceramic partition (112) disposed at the other end of the sealed molecular decomposition chamber (110) and separated from the cathode chamber (130), and having a plurality of through-holes sized to block undecomposed hydrogen molecules and water molecules while allowing decomposed hydrogen atoms to pass through; and
a carbon atom recombination prevention unit (113) having a copper wire or copper mesh structure, disposed within the molecular decomposition chamber (110) adjacent to the carbon-porous ceramic partition (111), electrically connected to the power generation line (170) to receive electrons therefrom, and supplying electrons to decomposed carbon atoms to prevent recombination thereof and blockage of the through-holes of the carbon-porous ceramic partition (111).

3. The hydrocarbon fuel cell of claim 1, wherein the pressure nozzle (140) injects the hydrocarbon fuel into the molecular decomposition chamber (110) in a mist form when the hydrocarbon fuel is methane gas, propane gas, or butane gas; and
injects the hydrocarbon fuel into the molecular decomposition chamber (110) in a vaporized form when the hydrocarbon fuel is liquid gasoline, liquid kerosene, or liquid diesel.

4. The hydrocarbon fuel cell of claim 1, wherein the anode chamber (120) includes:
a first oxygen inlet nozzle (121) mounted on one side surface of the sealed anode chamber (120) to receive oxygen supplied from the oxygen injection unit (160) into the anode chamber (120);
a carbon dioxide exhaust nozzle (122) that exhausts carbon dioxide generated from the reaction between carbon and oxygen within the sealed anode chamber (120) to the outside; and
an electron movement promotion unit (123) filling an interior of the sealed anode chamber (120) and formed by bending or curving copper wire multiple times into a cotton ball-like form, electrically connected to the carbon atom recombination prevention unit (113) to receive electrons therefrom, and promoting the movement of electrons that have passed through the carbon-porous ceramic partition (111) toward the P-type semiconductor sidewall (124).

5. The hydrocarbon fuel cell of claim 1, wherein the cathode chamber (130) includes:
a second oxygen inlet nozzle (131) mounted on one side surface of the sealed cathode chamber (130) to receive oxygen supplied from the oxygen injection unit (160) into the cathode chamber (130); and
a water vapor exhaust nozzle (132) that exhausts water vapor generated from the reaction between hydrogen and oxygen within the sealed cathode chamber (130) to the outside.
